(19) United States
(12) Patent Application Publication
(10) Pub. No.: US 2009/0140669 A1
(43) Pub. Date: Jun. 4, 2009

(54) Highly Directed, Adjustable Intensity Reading/Keyboard Light with Optimized Spectral Output

(76) Inventors: James W. Masten, JR., Seattle, WA (US); Thomas J. Brooks, Edmons, WA (US)

Correspondence Address: James W. Masten, Jr., 8528-14th Ave. NW, Seattle, WA, 98117, US

(21) Appl. No.: 12/324,511

(22) Filed: Nov. 26, 2008

Related U.S. Application Data
(60) Provisional application No. 60/990,563, filed on Nov. 27, 2007.

(51) Int. Cl. H05B 41/36

(52) U.S. Cl. 315/294

(57) ABSTRACT

A highly-directed light, with color in the blue area of the spectrum, has been developed that meets the particular requirements of two types of users. One application enables a user to see a keyboard clearly enough, predominately from his peripheral vision, to use it while engaged in other principal tasks. The other application allows readers with aging eyesight to more clearly focus on written text without the aid of magnifying or reading glasses. The user's ocular physiology, the physics of the light source and the juxtaposition of the working components for the typical operational scenario were considered while designing an apparatus and method to deliver an optimal working solution.

### CROSS-REFERENCES TO RELATED APPLICATIONS

This application claims priority to U.S. Provisional Application 60/990,563 filed on Nov. 27, 2007. The foregoing applications are hereby incorporated by reference in their entirety as if fully set forth herein.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

This invention seeks to address two different issues with lighting currently available to assist readers. The first issue is that of public safety officers trying to read their mobile data computer keyboards in uncertain light, at the same time wishing not to be illuminated themselves while within the vehicle. The second issue addresses the failing eyesight of the aging population, which causes increasing difficulty in reading in normal indoor lighting.

It is common to mount a dome light on the interior ceiling of an automobile to provide illumination for general purpose activities that require only a low level of light. Whereas such general illumination, even at a low level, does reflect off of the windshield and side glass making visibility to the outside more difficult, thus creating impairment and making driving more difficult. While at the same time such general illumination does enable an exterior view into the vehicle by direct view or by silhouette back-lighting.

Map lighting on the other hand is provided as a high-intensity light with a more focused beam rather than a general illumination. In this case the purpose is to enable reading of text and symbols. Map lighting is designed to minimize general illumination, reflection and silhouette back-lighting.

Neither of these general or specific lighting types was designed to address a special case of lighting requirement that has become commonplace in public safety vehicles of all types: police, fire, emergency, maintenance and service. All of these vehicles are now commonly fielded with various laptop or vehicle computers. These systems require an additional and novel lighting type designed especially for this new requirement.

Existing standard equipment on emergency vehicles currently in manufacture from all major suppliers includes a common general illumination dome light that provides either a fixed intensity white light or a fixed intensity red light illumination. This standard light mounts through the headliner using two unequal length spring clips. This light is approximately 5 inches in diameter and is equipped with a vehicle-type specific connector that connects to the standard wiring harness by vehicle brand.

Complaints by police officers that back-lit keyboards were confusing and hard to use prompted an investigation of operational procedure, back-lighting techniques and the human physiology of vision.

Operationally, the using police officer is driving at night and using opportunities in traffic to gain updates from the computer. Even though responses by the officer are designed to be brief and minimal, accurate keyboarding is still required. By definition the officer is reading the keyboard from his peripheral vision. The peripheral areas of the human eye are dominated by the “rod” receptors. The rod receptors are hundreds of times more sensitive to light than the “cone” receptors. But the cone receptors recognize color. In very low light situations, especially in the peripheral vision areas, the human eye sensitivity to color is very low. In fact, in most people the rod receptors don't see red with wavelengths beyond about 640 nm.

This explains why the officers find dissatisfaction with the back-lit keyboards, since nearly all back-lit keyboards are back lit with red LED's (Light Emitting Diodes) or on the older keyboards, red incandescent lights. The officers turned the back-light intensity up to maximum and still they did not easily orient themselves to the keyboard in the brief peripheral glances, as the operational situation required for their night operations. This apparatus and method is applicable to any in-vehicle application where directed light is required inside which does not illuminate the inside of the vehicle.

The eyesight of our aging population has similar difficulties. In the physiology of the eye, the cones (color receptors) are clustered in the center of the eye (approximately 1 cone per micron). As a person ages, the lens of the eye wears out and gets stiffer. The stiffness begins in the center, where the cones are clustered and the ability to see color is strongest. The periphery of the lens stays flexible longer, where the rods are which gather most of the light. But rods don't see wavelengths longer than about 640 nm, and typical reading lights have much of their spectrum at longer wavelengths. But since the rods don't receive these long-wavelength colors, to see clearly enough to read, older eyes need either light with shorter wavelengths, up in the “blue” area of the spectrum, or manual sight augmentation such as reading or magnifying glasses.

Even using an intense white light, shifted to blue, puts too much energy of the wrong spectrum into the center of the eye, which causes the iris to close down to restrict the light, depriving the eye of the needed blue light. What is needed is a light whose whole color spectrum is above the level that the rods can start to sense, wavelengths shorter that 640 nm.

### BRIEF DESCRIPTION OF THE INVENTION

The invention described herein uses blue LED's to create reading lights with no additional energy at longer wavelengths, to enhance the ability of the human eye to read clearly in otherwise uncertain light, or when aging eyes lose the ability to view clearly in broad spectrum lighting.

There are a number of implementations for this technology. One implementation of this technology would be for use in public safety vehicles, to illuminate devices within a vehicle, such as a keyboard, without illuminating the entire vehicle. And to allow users to read text or the keyboard in dim light, especially when their eyes are having trouble focusing or when they cannot look directly at the keyboard or text.

Another implementation is a reading light for people, especially older people, who can no longer focus clearly on written text because of the loss of flexibility in their lens. This type of blue reading light would provide light in the proper area of the spectrum, with sufficient focused intensity to enable reading without the use of reading or magnifying glasses for many in the aging population.

### BRIEF DESCRIPTION OF THE DRAWINGS

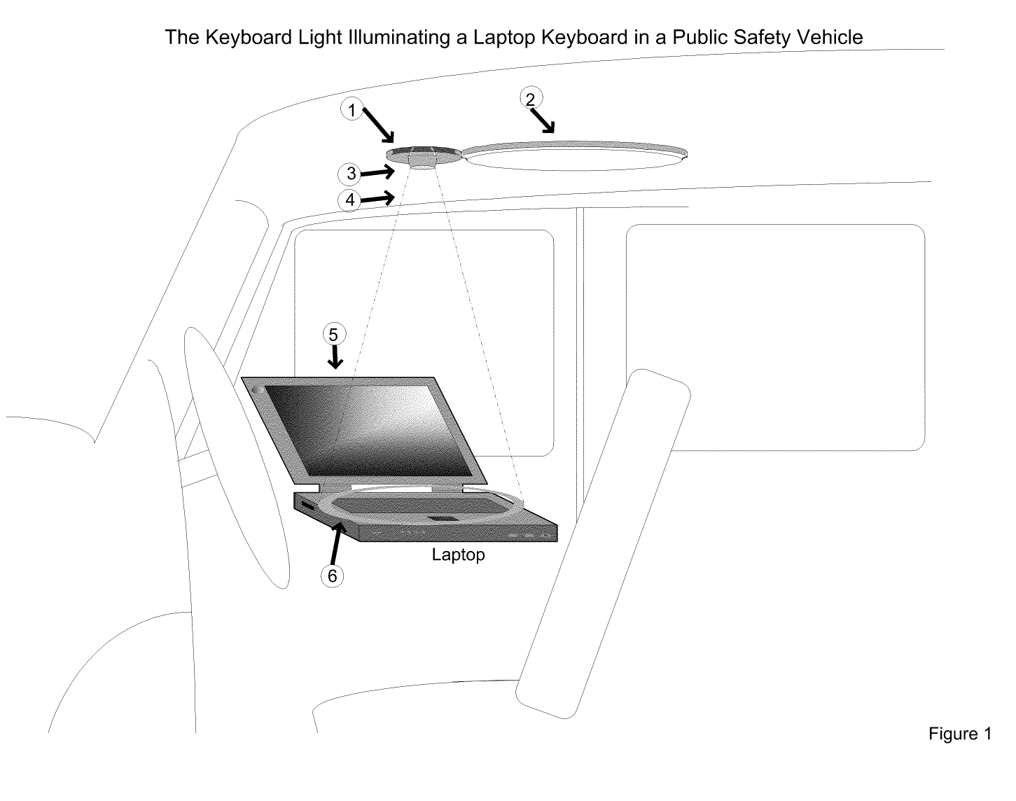

### FIG. 1: The Keyboard Light Illuminating a Laptop Keyboard in a Public Safety Vehicle

FIG. 1 illustrates the preferred embodiment of the typical installation in a public safety vehicle.

Item 1 identifies the keyboard light attached and powered through Item 2, the public safety vehicle dome light.

Item 3 identifies the adjustable lens that can be pointed up to 30° off of the vertical through all four quadrants, front, right, rear and left.

Item 4 is the narrow light beam that is sharply defined to illuminate just the area of the keyboard with an adjustable intensity.

Item 5 identifies the typical laptop, and Item 6 identifies the keyboard on the laptop and the outer ring of projected light from the light beam, Item 4.

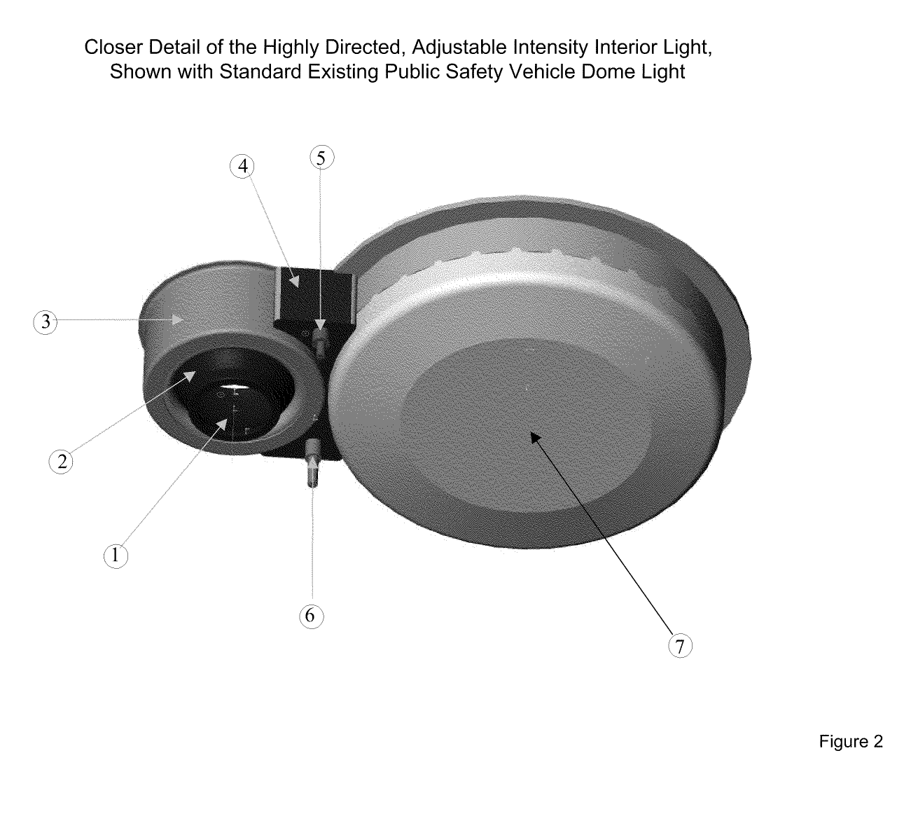

FIG. 2: Closer Detail of the Highly Directed, Adjustable Intensity Interior Light, Shown with Standard Existing Public Safety Vehicle Dome Light

FIG. 2 illustrates the details of the keyboard light.

Item 1 identifies the light beam from the sharply defining lens.

Item 2 identifies the lens mounting ball fixture that enables the aiming of the light.

Item 3 points to the light housing that is the reference housing for the lens mounting ball, Item 2.

Item 4 is the joining mount that accommodates the existing dome light in public safety vehicles and provides a mount for the keyboard light as well as the mount for the on/off switch (Item 5) and the dimming rheostat (Item 6).

Item 7 is the existing public safety dome light.

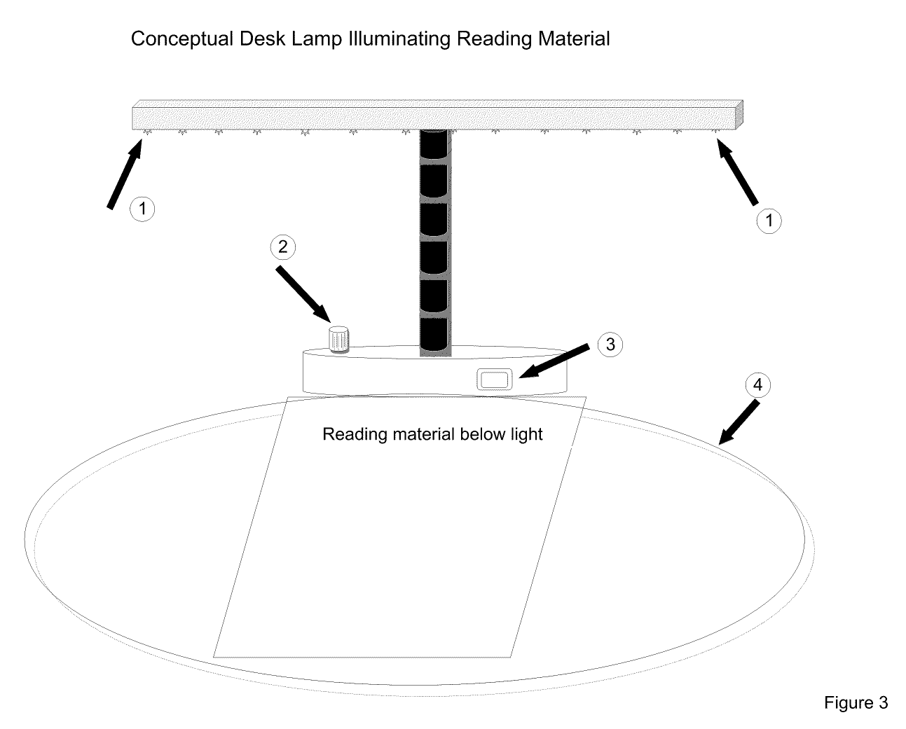

### FIG. 3: Conceptual Desk Lamp Illuminating Reading Material

FIG. 3 shows a conceptual desk lamp using blue LED's for illumination, with its projected area of illumination.

Items 1 indicate the placement of LED's within the head of said desk lamp.

Item 2 indicates a dimmer knob for controlling the intensity of the LED output.

Item 3 indicates the on/off power switch for the lamp's power source.

Item 4 indicates a projected area of illumination.

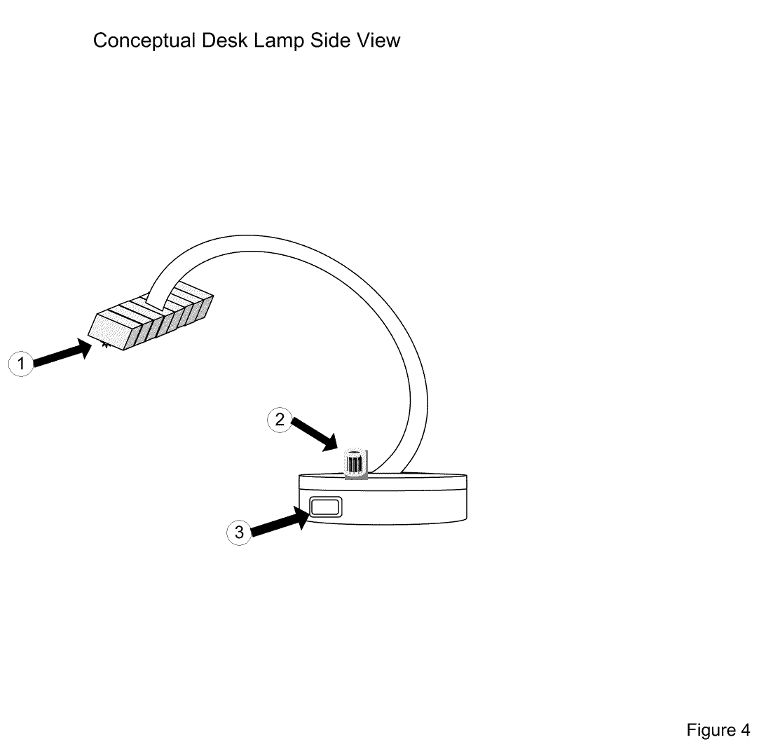

### FIG. 4: Conceptual Desk Lamp Side View

FIG. 4 shows a side view of a conceptual desk lamp using blue LED's for illumination.

Item 1 indicates the placement of LED's within the head of said desk lamp.

Item 2 indicates a dimmer knob for controlling the intensity of the LED output.

Item 3 indicates the on/off power switch for the lamp's power source.

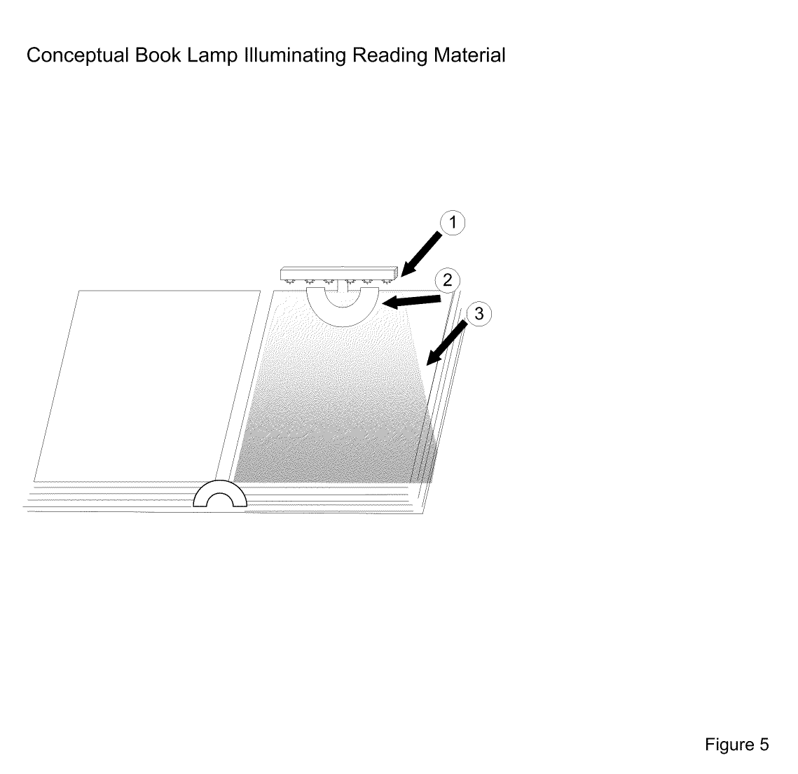

### FIG. 5: Conceptual Book Lamp Illuminating Reading Material

FIG. 5 shows a side view of a conceptual portable book light using blue LED's for illumination, with its projected area of illumination.

Item 1 indicates the placement of LED's within the head of said desk lamp.

Item 2 indicates conceptual device for attaching said book light to reading material, such as a book.

Item 3 indicates a projected area of illumination.

### SPECIFICATION

A simple reading light specification is a subset of the vehicle specification, the reading light application having no concern for windshield glare or silhouette illumination. But all concerns for spectrum, intensity and field of coverage are valid for both public safety applications and general reading in an aging population.

For the public safely application, this new light type is mounted to the ceiling of the vehicle. It is adjustable in intensity from no light output to a high level of output such that fine detailed reading is possible. The beam definition of this light is very sharp while being very uniform across the beam. The beam width at the keyboard should be just as large as the keyboard. The pointing direction of the light is adjustable throughout an area that covers the general area of keyboard placement in the vehicles and enables use of the light for the purpose of illuminating the keyboard from either front seat.

Another issue may come into play in this scenario: the typical human eye has a little less than 100-to-1 instantaneous dynamic range. This means that when the officers turn the keyboard brightness up in an effort to see it, the keys themselves and the other features of the keyboard are lost because they are less than 1% as bright as the lights in the keyboard.

Since most keyboards have the character symbol struck or printed on the key top in high contrast, the officer in his peripheral vision easily recognizes illumination from above with a nearly pure blue light. This is true even if the light intensity is a small fraction of the intensity used unsuccessfully in the red light back-lit keyboards. The soft blue light from above illuminates the entire keyboard, bringing all of the keyboard features into recognition by the officer.

To be most effective, the light source should be located above the keyboard or reading material so that the light beam has a nearly vertical path to the keyboard. This orientation provides the highest contrast and the least reflected glare, thus delivering the most ideal illumination for the operational situation.

Since the sensitivity to light in the peripheral vision area varies widely across the population, the keyboard light needs to be fully adjustable as to pointing angle and intensity. In the preferred embodiment, as illustrated in FIGS. 1 and 2, the pointing angle is adjusted by positioning the lens mounting ball in the housing socket of the light housing. The intensity is modulated using a rheostat to change a reference signal to the pulse width modulation component of the DC-to-DC converter that supplies a constant voltage and a variable current to the high-performance LED light source.

The preferred embodiment of the light is designed to mount to the existing emergency vehicle dome light and “tap” into the power connections within the current dome light. Thus no additional wiring connections need to be made to mount the adjustable keyboard light within the vehicle.

The use of a high-efficiency LED lighting source is the key to the unique capabilities of the light and to using the existing emergency vehicle light as the host to physically mount and to provide electrical energy for the keyboard light. The LED source provides more than 80 lumens of illumination while drawing approximately one Watt of electrical power. Since the dome light electrical wiring of the vehicle is designed with a safety factor of more than three hundred percent, and the keyboard light draws less than 10% of the dome light design requirement, the electrical load is well within the safety requirements of the vehicle manufacturer.

Officers using this type of lighting report rapid adaptation and ease of use within their operational requirement. This system meets their operational objectives of sufficient illumination on the keyboard, very little general illumination so as not to increase their visibility to the outside either by direct illumination or by silhouette, and very low impact on the officer's driving ability or his night vision capability.

For the aging eyesight reading application, the pure blue illumination using LED's can be housed in an apparatus adapted as either a desk lamp or a hand-held light for use in typical daily reading applications. The reading lamp has a power source, either AC or DC, and a dimming switch for adjusting the intensity of the LED's for reading. FIGS. 3 and 4 show a conceptual drawing for a typical desk lamp apparatus; FIG. 5 shows a conceptual drawing for a portable book light.

What is claimed is:

1. An apparatus and method for implementing a reading/keyboard light which enables non-augmented reading vision in uncertain light or when user's eyesight cannot properly receive energy within wavelengths longer than 640 nm. Said apparatus and method are based on the use of one or more LED (Light Emitting Diodes) lights having energy emission in the blue color spectrum. Said apparatus and method comprising
a) one or more blue LED's arranged behind a lens;
b) said lens being a focusing lens to put 95% of the released blue light energy on the target area to be observed and comprehended;
c) a dimming switch to enable smooth dimming of said blue LED's illumination to effect a minimum dynamic range requirement on the part of the user;
d) a power source, either AC or DC, for powering said LED's;
e) a power switch for turning on or off connection to said power source.
